(19) United States
(12) Patent Application Publication
(10) Pub. No.: US 2006/0259330 A1
(43) Pub. Date: Nov. 16, 2006

(54) ELECTRONIC PRESCRIPTION SYSTEM FOR INTERNET PHARMACIES AND METHOD THREFOR

(76) Inventor: Paul Steven Schranz, Bowen Island (CA)

Correspondence Address: PAUL STEVEN SCHRANZ, BOX G-30 RR1, BOWEN ISLAND, BC, V0N 1G0, CA

(21) Appl. No.: 11/308,807

(22) Filed: May 10, 2006

Related U.S. Application Data
(60) Provisional application No. 60/594,824, filed on May 10, 2005.
(60) Provisional application No. 60/594,973, filed on May 23, 2005.

(51) Int. Cl. G06F 19/00; G06K 19/00

(52) U.S. Cl. 705/3; 235/487

(57) ABSTRACT

An electronic prescription system that includes a first prescription processor, a second prescription processor and a third prescription processor. The first prescription processor is configured to provide prescription information for creating an electronic prescription for a patient. The second prescription processor is configured to provide an electronic prescription processing service. The third prescription processor is configured to accept a sequence of digits representative of the electronic prescription from the patient and to provide the second prescription processor with the sequence of digits.

### CROSS REFERENCE TO RELATED APPLICATIONS

This application claims the benefit of the earlier filed U.S. Provisional Patent Application Nos. 60/594,824 and 60/594,973.

### BACKGROUND OF THE INVENTION

1. Field of the Invention

The present invention provides a system and method for registering and filling an electronic prescription, and in particular for use with Internet pharmacies.

2. Description of Related Art

There is an increase in the use of Internet pharmacies. A person who has a valid conventional prescription can fill the prescription by ordering the medicine from an Internet pharmacy. The person must mail in or fax the prescription to the Internet pharmacy. It is possible for fraudulent prescriptions to be filled by Internet pharmacies.

Canadian Patent Application No. 2,475,959 by KOBYLEVSKY et al., filed Feb. 6, 2003, discloses a method and apparatus for providing prescription, prescription refill, transcription, and forwarding services using voice recognition software and associated computer hardware.

### SUMMARY OF THE INVENTION

In a first aspect of the present invention there is provided an electronic prescription system that includes a first prescription processor, a second prescription processor and a third prescription processor. The first prescription processor is configured to provide prescription information for creating an electronic prescription for a patient. The second prescription processor is configured to provide an electronic prescription processing service. The third prescription processor is configured to accept a sequence of digits representative of the electronic prescription from the patient and to provide the second prescription processor with the sequence of digits.

In a second aspect of the present invention there is provided an electronic prescriptions method for providing an electronic prescription service to a patient. The method includes the steps of providing the patient with a sequence of digits representative of the electronic prescription, and the patient providing the sequence of digits representative of the electronic prescription over the Internet.

In a third aspect of the present invention there is provided an electronic prescriptions apparatus for providing an electronic prescription service to a patient. The apparatus includes a means for providing the patient with a sequence of digits representative of the electronic prescription, and a means for the patient providing the sequence of digits representative of the electronic prescription over the Internet.

In a fourth aspect of the present invention there is provided a computer program stored on a computer-readable medium. The computer program includes instructions to provide a graphical user interface for entering prescription information for a patient, to create an electronic prescription from the prescription information obtained by the graphical user interface, and to provide a sequence of digits representative of the electronic prescription to the patient.

In a fifth aspect of the present invention there is provided a computer program stored on a computer-readable medium. The computer program includes instructions to provide a patient with Internet access to an Internet pharmacy storefront for buying pharmaceuticals, and to receive a sequence of digits representative of an electronic prescription from the patient.

In a sixth aspect of the present invention there is provided a computer program stored on a computer-readable medium. The computer program includes instructions to provide a sequence of digits representative of an electronic prescription to a prescription authority to fill the prescription, and to receive a response from the prescription authority indicating the result of filling an electronic prescription.

The present invention advantageously reduces prescription fraud at Internet pharmacies.

The present invention allows a patient with an electronic prescription to shop around on the Internet for the best price for a drug.

The present invention advantageously allows Internet pharmacies to eliminate labor intensive audits of mailed or faxed prescriptions.

The present invention advantageously eliminates conventional prescriptions that are difficult to read because of poor hand writing. This also reduces the likelihood of a patient receiving the wrong dosage or instructions from the pharmacy on the medicine label.

The present invention allows an electronic prescription to be automatically verified against a set of prescription rules and then digitally signed by a physician authorized to prescribe medicine in the region the electronic prescription is being filled and the medication dispensed.

It is an advantage of the present invention that each refill for an electronic prescription can be filled at a different Internet pharmacy than Internet pharmacies used previously for the electronic prescription.

### BRIEF DESCRITION OF THE DRAWINGS

The invention will be more readily understood by the description of preferred embodiments thereof given, by way of example only, with reference to the accompanying drawings, in which:—

FIG. 1 is a simplified block diagram view of a system for registering and filling an electronic prescription according to a first embodiment of the invention;

FIG. 2 is a simplified block diagram of the software architecture of an electronic prescription repository server of the system of FIG. 1;

FIG. 3 is a simplified block diagram of the software architecture of an Internet pharmacy server of the system of FIG. 1;

FIG. 4 is a simplified block diagram of a system for registering and filling an electronic prescription according to a second embodiment of the invention;

FIG. 5 is a simplified block diagram of the software architecture of a physician repository server of the system of FIG. 4;

FIG. 6 is a simplified block diagram of a software architecture according to a third embodiment of the present invention;

FIG. 7 is a simplified collaboration diagram of the embodiment of FIG. 6;

FIGS. 8A-D are block diagrams illustrating a digital signing procedure of the embodiment of FIG. 6;

FIG. 9 is a simplified block diagram of a software architecture according to a fourth embodiment of the present invention;

FIG. 10 is a simplified collaboration diagram of the embodiment of FIG. 9;

FIGS. 11-22 are simplified collaboration diagrams each according to another embodiment of the present invention;

FIG. 23 is a simplified collaboration diagram according to another embodiment of the present invention;

FIG. 24 is a simplified collaboration diagram according to another embodiment of the present invention; and

FIG. 25 is a simplified collaboration diagram according to another embodiment of the present invention.

### DETAILED DESCRIPTION OF THE INVENTION

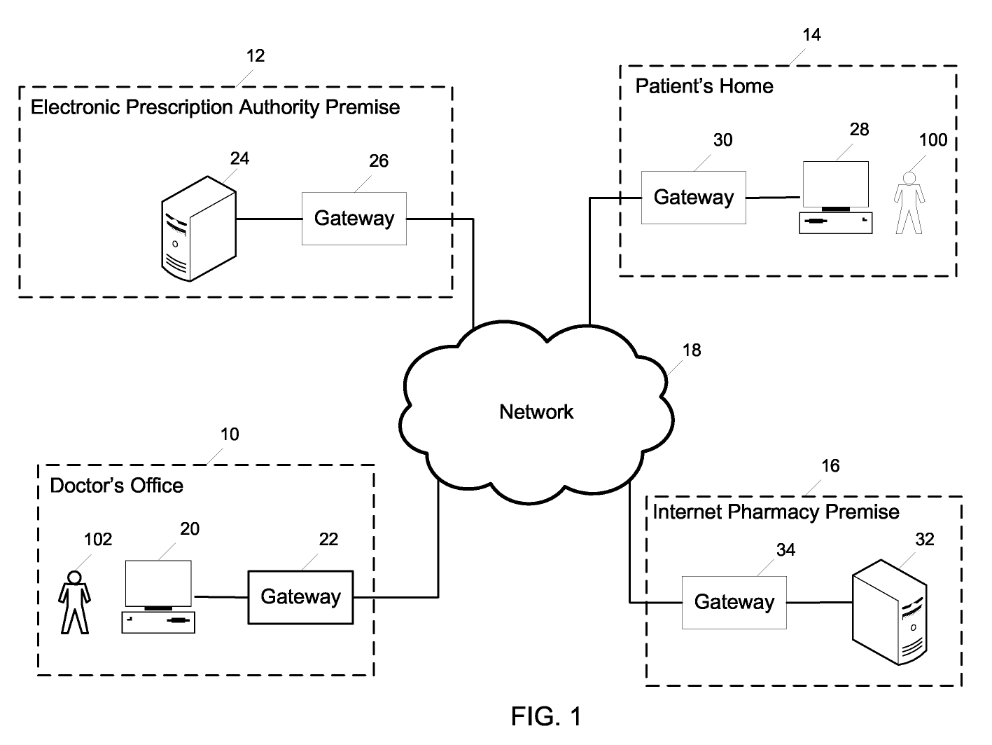

Referring to FIG. 1, there is a doctor's office 10, an electronic prescription authority premise 12, a patient's home 14, an Internet pharmacy premise 16 and a network 18 in one embodiment of the present invention. The doctor's office 10 comprises a personal computer 20 and a gateway 22. The electronic prescription authority premise 12 comprises a server 24 and a gateway 26. The patient's home 14 comprises a personal computer 28 and a gateway 30. The Internet pharmacy premise 16 comprises a server 32 and a gateway 34. The network 18 comprises the Internet and may comprise other types of networks, for example the PSTN and cellular networks, as well. The term Internet pharmacy is used herein to refer to a pharmacy that has an online storefront where a patient can fill an electronic prescription by purchasing their prescribed medicine on the Internet, for example by an online credit card transaction. The purchased medicine is then delivered to the patient's shipping address. Other methods of payment are possible.

The personal computer 20 at the doctor's office 10 is a conventional personal computer and comprises a microprocessor, dynamic RAM, a hard disk, a printer, a monitor, a keyboard and a mouse in this example. The gateway 22 couples the personal computer 20 to the network 18 and comprises an xDSL modem in this example, and can comprise a cable modem, a dial-up modem, a GPRS modem, a CDMA modem or other types of modems for connecting to the Internet in other examples. The personal computer 20 further comprises the Windows XP® operating system in this example, and can comprise other operating systems, for example, without limitation, Linux, Mac OS and other Microsoft operating systems. It is understood that the personal computer 20 also comprises the Internet Explorers browser in this example, and can comprise other web browsers, for example, Mozilla and Firefox, in other examples.

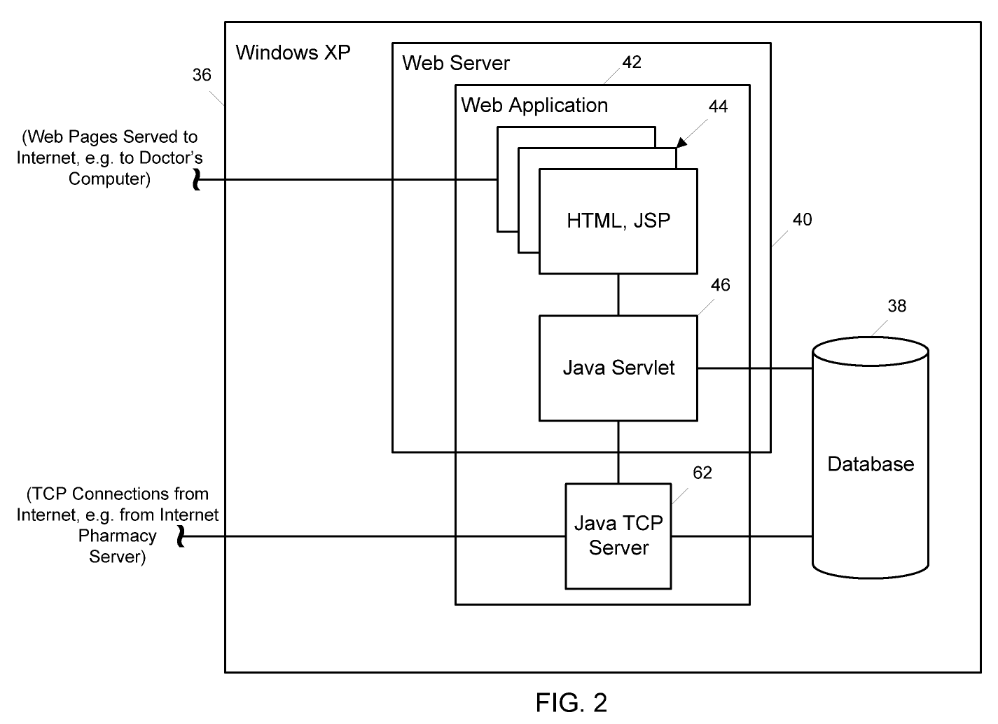

Referring to FIGS. 1 and 2, the server 24 at the electronic prescription authority premise 12 is a conventional personal computer, in this example, and comprises a microprocessor, dynamic RAM, a hard disk, a monitor, a keyboard and a mouse. The server 24 can comprise other types of conventional servers in other examples, such as, without limitation, an IBM server or a Sun Microsystems server. The server 24 further comprises an operating system 36, which comprises the Windows XP® operating system and a Java Virtual Machine (JVM) in this example. The operating system 36 can comprise other operating systems, for example, without limitation, Linux, UNIX, and other Microsoft operating systems, in other examples. The gateway 26 couples the server 24 to the network 18 and comprises an xDSL modem in this example, and can comprise a cable modem, a dial-up modem, a GPRS modem, a CDMA modem or other types of modems for connecting to the Internet in other examples.

The server 24 also includes a web server 40, a web application 42 and an electronic prescription repository in the form of a database 38. The database 38 comprises Microsoft SQL Servers in this example, and can comprise other databases, for example, without limitation, MySQL® and Oracle 10i® in other examples. The web server 40 comprises the Apaches web server and Tomcat servlet container, in this example, and can comprise other web servers, for example, without limitation, iPlanet® from Netscape and Resin from Caucho, in other examples.

The web application 42 of the server 24 comprises web pages indicated generally by reference numeral 44 in the form of Hypertext Markup Language (HTML) and Java Server Pages (JSP) pages, a Java servlet 46 and a Java TCP server 62. The Java servlet 46 and Java TCP server 62 each have connections to the database 38. The web pages 44 are served by the websever 40. The web application 42 has an URL (web address) associated with it which can be entered into a web browser address box so that the web application and its content can be accessed from the Internet.

Referring to FIG. 1, the personal computer 28 at the patient's home 14 is a conventional personal computer, in this example, and comprises a microprocessor, dynamic RAM, a hard disk, a monitor, a keyboard and a mouse. The gateway 30 couples the personal computer 28 to the network 18 and comprises an xDSL modem in this example, and can comprise a cable modem, a dial-up modem, a GPRS modem, a CDMA modem or other types of modems for connecting to the Internet in other examples. The personal computer 28 further comprises the Windows XP® operating system in this example, and can comprise other operating systems, for example, without limitation, Mac OS, Linux and other Microsoft operating systems, in other examples. It is understood that the personal computer 28 also comprises the Internet Explorers browser in this example, and can comprise other web browsers, for example, Mozilla and Firefox, in other examples.

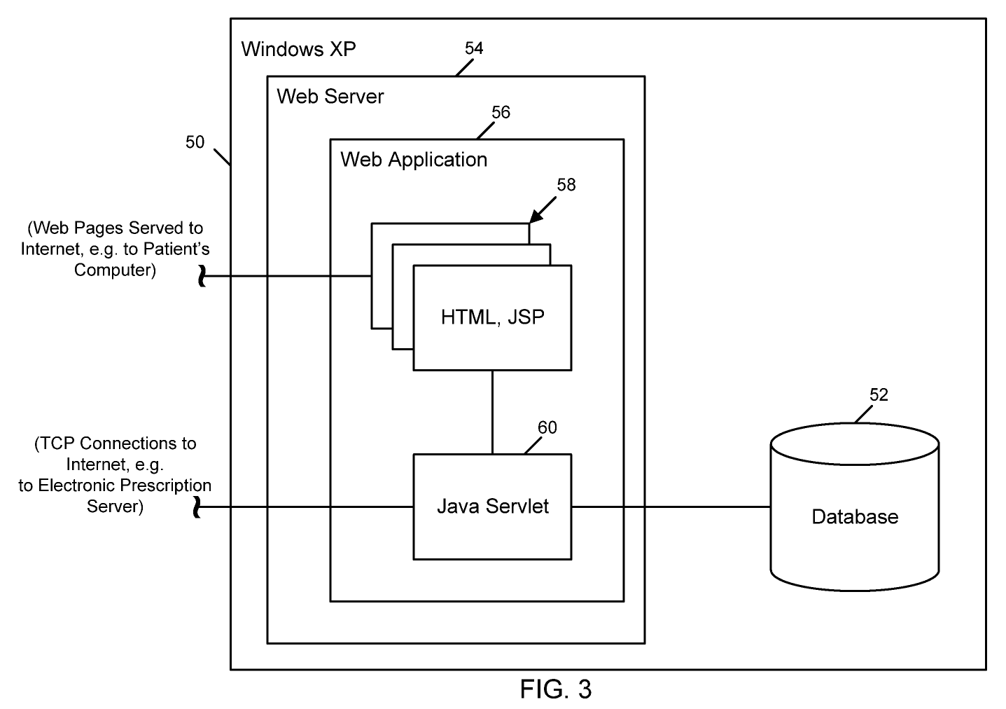

Referring to FIGS. 1 and 3, the server 32 of the Internet pharmacy premise 16 is a conventional personal computer, in this example, and comprises a microprocessor, dynamic RAM, a hard disk, a monitor, a keyboard and a mouse. The server 32 can comprise other types of conventional servers in other examples, such as, without limitation, an IBM server or Sun Microsystems server. The server 32 further comprises an operating system 50, which is the Windows XP® operating system and a JVM in this example, and can comprise other operating systems in other examples. The operating system 50 can comprise other operating systems, for example, without limitation, Linux, UNIX, and other Microsoft operating systems, in other examples. The gateway 34 couples the server 32 to the network 18 and comprises an xDSL modem in this example, and can comprise a cable modem, a dial-up modem, a GPRS modem, a CDMA modem or other types of modems for connecting to the Internet in other examples.

The server 32 also includes a web server 54, a web application 56 and a database 52. The database 52 comprises Microsoft SQL Servers in this example, and can comprise other databases, for example, without limitation, MySQL® and Oracle 10i® in other examples. The web server 54 comprises the Apaches web server and Tomcat servlet container, in this example, and can comprise other web servers, for example, without limitation, iPlanet® from Netscape and Resin from Caucho, in other examples.

The web application 56 of the server 32 comprises web pages indicated generally by reference numeral 58 in the form of HTML and JSP pages and a Java servlet 60. The web pages 58 are served by the websever 54. The web application has an URL (web address) associated with it which can be entered into a web browser address box so that the web application and its content can be accessed from the Internet.

The electronic prescription repository database 38 on the server 24 has at least one database table containing information on doctors who are authorized to prescribe medicine. The table includes authentication parameters for each of the doctors so that the doctors may be authenticated as described below in more detail. The authentication information is a username and password in this example, but can also be other types of authentication information, for example, without limitation, a digital certificate issued and verified by a Certificate Authority (CA) and used as part of a public key infrastructure.

In operation, a patient 100 has a doctor's appointment with a doctor 102 at the doctor's office 10. The doctor 102 decides to prescribe medicine to the patient 100 by registering an electronic prescription. The doctor 102 enters the URL (web address) for the web application 42 of the server 24 at the electronic prescription authority premise 12 in the web browser on his computer 20. The web application 42 delivers a login page to the web browser on the computer 20. The doctor 102 enters his username and password and submits them to the web application 42 for processing. The web application 42 cross-references the username and password submitted by the physician with the database 38, and if they are correct, the web application delivers the electronic prescription registration page.

The protocol used between the web browser on the computer 20 and the web application 42 on server 24 is https, a secure protocol, in this example, but is not required to be in other examples. Other secure protocols can be used in other examples, such as IPsec. There could also be a Virtual Private Network (VPN) network arrangement. It is not a requirement that a secure protocol be used, however it is preferable.

The doctor 102 proceeds to fill in the information necessary for a conventional prescription, for example, without limitation, the patients name, the patients medical insurance identification number (if there is such a number), the drug prescribed, the dosage, the number of times the prescription can be refilled and the instructions for taking the drug. After the doctor enters all required information the doctor submits the electronic prescription registration request to the web application 42 on the server 24. It is understood that when the doctor 102 submits the request the doctor's information is also associated with that request, for example, without limitation, the doctor's name, address and digital signature.

The web application 42 receives the request and stores the electronic prescription in the database 38, which contains the electronic prescription repository, and delivers a response page to the web browser on the computer 20. The response page includes a unique identification number for the electronic prescription. The doctor 102 prints the response page and gives it to the patient 100. The electronic prescription is now electronically prescribed.

If the patient 100 has an email account, the web application 42 can also email the information provided for in the response page to the patients email account. This is convenient for the patient 100 and more fail-safe, e.g. the patient 100 may lose the printed page received from the doctor 102.

In some embodiments, the printed response page may be formatted in the style of a conventional prescription, i.e. has sufficient information to be a conventional prescription. In this situation the doctor 102 can sign the response page so that the patient 100 may use it as a conventional prescription if the patient 100 decides to visit a brick and mortar pharmacy instead of shopping at Internet pharmacies. This is described in more detail below.

It is understood that in other examples, the doctor does not need to use a personal computer 20, but can use any computing device that is connected to the Internet, for example, without limitation, a PDA, a Blackberry device, a pocket PC, a cellular phone or a tablet PC.

The doctor 102 can view, modify and delete any electronic prescription that the doctor has registered with the database 38 by using the web browser on computer 20 to access the web application 42 on the electronic prescription authority server 24. The web application 42 has corresponding web pages for viewing, modifying and deleting electronic pages. After the electronic prescriptions are filled, as described below, the doctor can no longer modify or delete them.

The patient 100 can view any electronic prescription prescribed to them using the web browser on computer 28 to access the web application 42 on the electronic prescription authority server 24.

When the patient 100 wants to fill the electronic prescription they enter the URL (web address) of the web application 56 executing on the server 32 at the Internet pharmacy premise 16 in the web browser address box of the computer 28. It is understood that the patient 100 does not need to use their home computer 28 in other examples, and can use any computer that has a web browser and access to the Internet. The patient can also use in other examples any computing device that is connected to the Internet, for example, without limitation, a PDA, a Blackberry device, a pocket PC, a cellular phone or a tablet PC.

The web application 56 serves a fill prescription page to the web browser on computer 28. The patient 100 enters the unique electronic prescription identification number and other required information, for example, without limitation, their address, their telephone number, their medical insurance identification number and payment information. Once all the required information has been entered the patient 100 submits the fill prescription request to the web application 56.

The web application 56 uses the information submitted in the fill prescription request to validate the electronic prescription with the electronic prescription authority server 24. The web application 56 opens a secure communication channel with the electronic prescription authority server 24. In this example the Java servlet 60 on server 32 opens a TCP connection with the Java TCP Server 62 on server 24. After the communication channel is open the web application 56 requests validation of the electronic prescription by submitting the same information to the Java TCP Server 62 as submitted by the patient. The Java TCP Sever 62 uses the electronic prescription identification number to look up a corresponding record in the electronic prescription repository in database 38.

If there is a corresponding record and if the information submitted by the patient is correctly cross-referenced with the information in the electronic prescription record in the database 38 then the electronic prescription is flagged as filled in the electronic prescription repository database 38 and a validated response is returned to the Java servlet 60 in the web application 56 on the server 32. The web application 56 then returns a response page to the patient 100 with a positive result. The medicine associated with the prescription is then delivered to the patient. After the electronic prescription is filled it can not be filled again, unless the electronic prescription has refills associated with it.

If there is not a corresponding record or if the information submitted by the patient is incorrectly cross-referenced with the information in the electronic prescription record in the database 38 then the electronic prescription is flagged with a failed prescription fill attempt in the electronic prescription repository database 38 and a not-validated response is returned to the Java servlet 60 in the web application 56 on the server 32. The web application 56 then returns a response page to the web browser on the computer 28 of the patient 100 with a negative result and a reason for the result. The medicine associated with the prescription is not delivered to the patient.

In another example, the personal computer 20 of the doctor's office 10 can have a software application. When the doctor registers the electronic prescription the software application also submits information identifying the computer from which the registration request was sent. The information identifying the computer 20 can comprise, for example, without limitation, the Ethernet address of a Network Interface Card (NIC) or an identification number of the microprocessor. Since the doctor must submit authentication information, for example their username and password, this allows the web application 42 of the server 24 to cross-reference the authentication information with the information identifying the computer 20. This allows the web application 42 to require that electronic prescription registration requests from a particular doctor to also be from a particular computer. This advantageously provides more security against fraudulent registrations of electronic prescriptions.

It is possible for a patient with an electronic prescription to go to a conventional pharmacy and have the electronic prescription filled by the pharmacist at that conventional pharmacy. The pharmacist would use the same procedure to fill the electronic prescription outlined above for the patient 100.

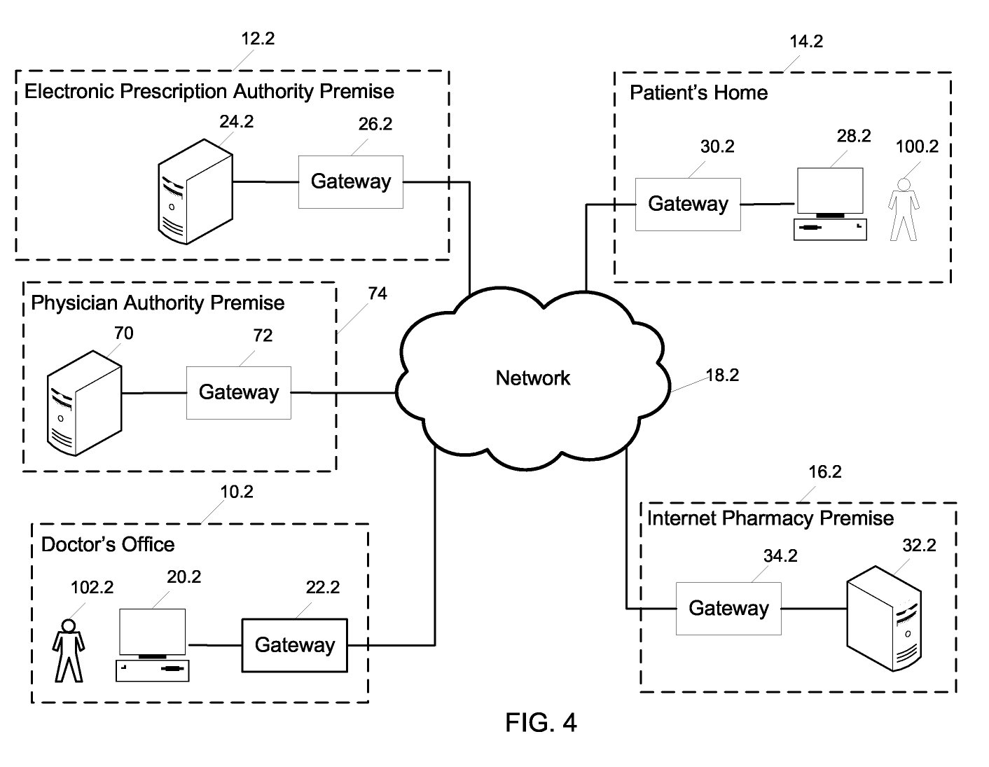

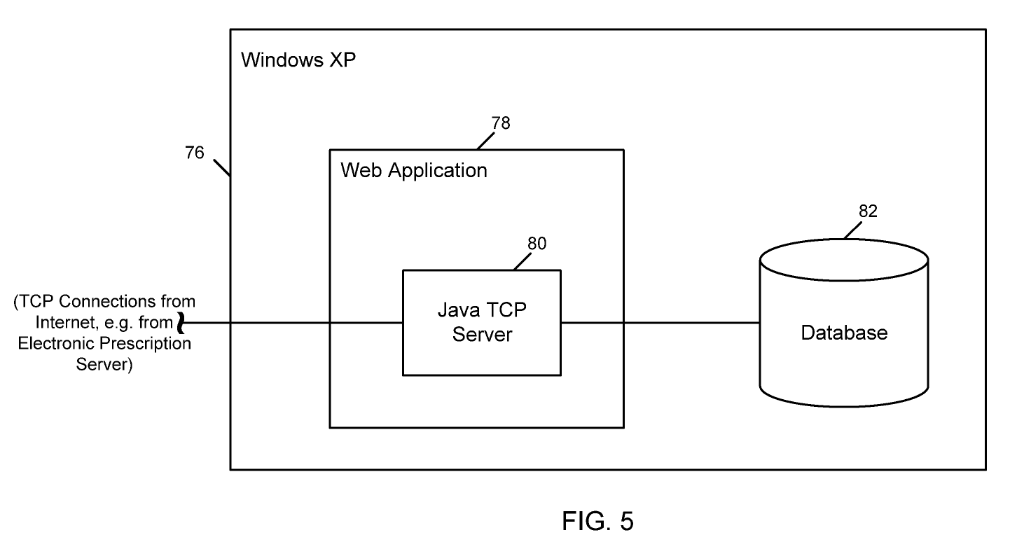

Referring now to FIGS. 4 & 5, a second embodiment of the present invention is shown, wherein like parts have like reference numerals with an additional suffix “.2”, which is similar to the embodiment of FIG. 1 with the addition of a physician authority premise 74. The physician authority premise 74 comprises a server 70 and a gateway 72. The server 70 is a conventional personal computer, in this example, and comprises a microprocessor, dynamic RAM, a hard disk, a monitor, a keyboard and a mouse. The server 70 can be other types of conventional servers in other examples, such as, without limitation, an IBM server or Sun Microsystems server.

The server 70 further comprises an operating system 76, which is the Windows XP® operating system and a JVM in this example. The operating system 70 can comprise other operating systems, for example, without limitation, Linux, UNIX, and other Microsoft operating systems, in other examples. The gateway 72 couples the server 70 to the network 18 and comprises an xDSL modem in this example, and can comprise a cable modem, a dial-up modem, a GPRS modem, a CDMA modem or other types of modems for connecting to the Internet in other examples.

The server 70 also includes a web application 78 and a physician repository in the form of a database 82. The database 82 comprises Microsoft SQL Servers in this example, and can comprise other databases, for example, without limitation, MySQL® and Oracle 10i® in other examples. The web server 54 comprises the Apaches web server and Tomcat servlet container, in this example, and can comprise other web servers, for example, without limitation, iPlanet® from Netscape and Resin from Caucho, in other examples. The web application 78 of the server 70 comprises a Java TCP Server 80.

The physician repository database 82 stores information related to authenticating physicians who are attempting to register, view, modify or delete electronic prescriptions in the electronic prescription repository database 38 of FIG. 2. The electronic prescription authority server 24.2 uses the physician authority server 70 and database 82 to authenticate physicians instead of authenticating them directly. In this example, authentication is part of a public key infrastructure using digital certificates, however it does not need to be in other examples. Physician 102.2 has a digital certificate and a public/private key pair, and web application 42 on the electronic prescription authority server 24.2 has a digital certificate and a public/private key pair.

In operation, the physician 102.2 first encrypts their digital certificate with their private key on computer 20.2 and submits this to the web application 42 on the electronic prescription authority server 24.2. The web application 42 then forwards this information over a communication channel to the web application 78 on the physician authority server 70 which decrypts it with the public key of the physician 102.2. In this example, the communication channel between the server 70 and server 24.2 is secure, and it is preferred that the channel is secure, but it does not need to be in other examples. The web application 78 on the physician authority server 70 responds to the web application 42 on the electronic prescription authority server 24.2 indicating whether the decryption was a success or a failure. Alternatively, the web application 42 on the electronic prescription authority server 24.2 can request the public key of the physician 102.2 from the web application 78 on the physician authority server 70 and can perform the decryption itself.

Once the physician 102.2 is authenticated, the physician 102.2 can communicate information securely to the web application 42 on the electronic prescription authority server 24.2 by encrypting the information with the public key of the web application 42, and the web application 42 can communicate information securely to the computer 20.2 by encrypting it with the physician's private key.

This example is advantageous when the electronic prescription authority server 24 is not warehousing physician information. In this example, the physician authority server 70 and database 82 could be operated by a governmental agency, a non-governmental organization (NGO) or a physician licensing organization, and the electronic prescription authority server 24 could be operated by a separate organization.

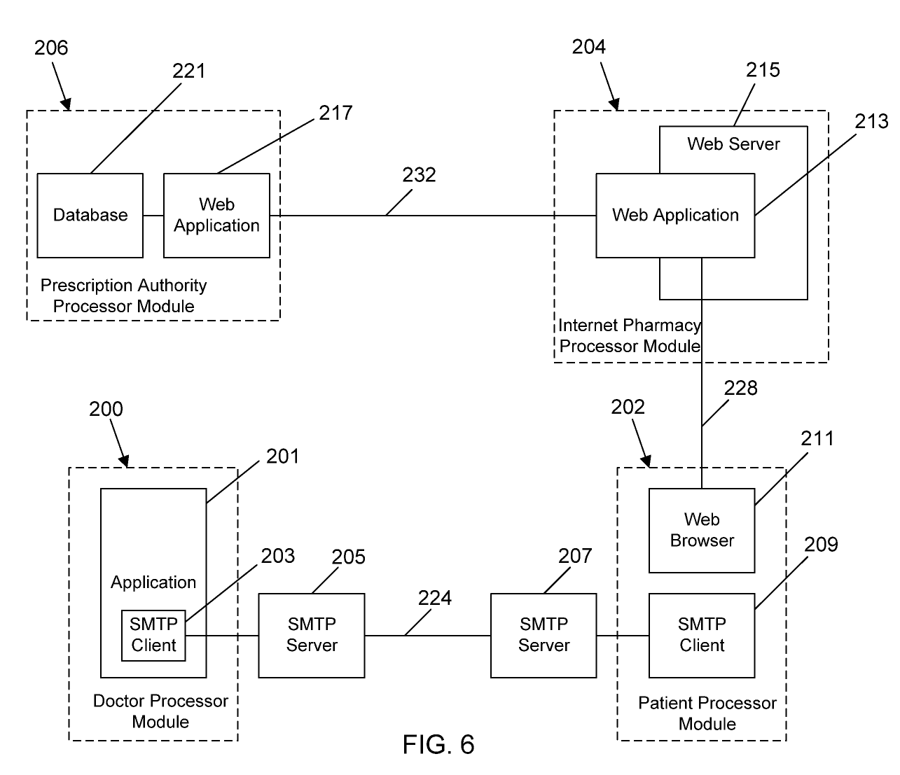

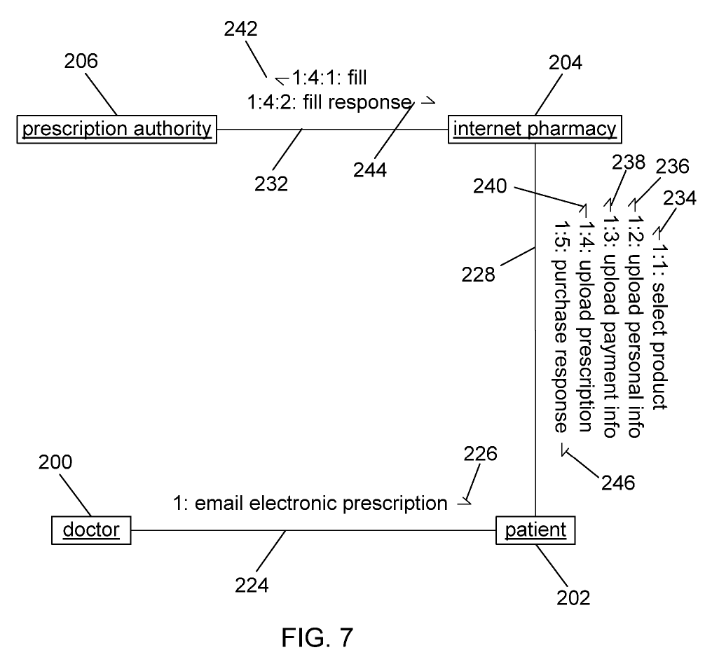

Referring now to FIGS. 6, 7 & 8a-d, a third embodiment of the system and method of the present invention is shown, wherein like parts have like reference numerals with an additional suffix “.3”. The present embodiment is exemplified by a software architecture shown in FIG. 6 and a collaboration diagram shown in FIG. 7 which illustrates the message flow between elements in the software architecture. The elements in the software architecture and the collaboration diagram comprise a doctor module 200, a patient module 202, an Internet pharmacy module 204 and a prescription authority module 206, all of which comprise software code (instructions) and which may be embodied permanently or temporarily in any type of machine, component, physical or virtual equipment, storage medium, or propagated signal capable of providing instructions to a device.

This embodiment has a network architecture similar to the previous embodiments and as illustrated in FIGS. 1 & 4. For example, the doctor module 200 can execute on the personal computer 20, the patient module 202 can execute on the personal computer 28, the Internet pharmacy module 204 can execute on the server 32 and the prescription authority module 206 can execute on the server 24, and messages in FIG. 7 can go over the network 18

The doctor module 200 comprises a software application 201 and an email SMTP client 203, and operates to generate electronic prescriptions. The software application 201 can execute on a personal computer, for example, but other platforms are also possible. The SMTP client 203 is used to email the electronic prescriptions to the patient module 202 over an email association 224. As is understood by those skilled in the art, the SMTP client 203 must be configured to operate with an email account on an SMTP server 205 in order to send emails. The SMTP server 205 is typically managed by an Internet Service Provider, but this is not a requirement. The doctor module 200 enables a doctor to enter the prescription information described in previous embodiments for a patient.

The patient module 202 comprises an email SMTP client 209 and a web browser 211 in this example, and is associated with the doctor module 200 by the email association 224 and with the Internet pharmacy module 204 by an http (or https) association 228. In other examples, the patient module 202 can comprise a software application that can receive email and communicate with web applications on web servers using http (or https). The email client and the web browser can execute on a personal computer, for example, but other platforms are also possible. The SMTP client 209 and the web browser 211 are common software applications found on personal computers, e.g. Outlook Express and Internet Explorer as found on the Windows operating system. As is understood by those skilled in the art, the SMTP client 209 must be configured to operate with an email account on an SMTP server 207 in order to send emails. The SMTP server 207 is typically managed by an Internet Service Provider, but this is not a requirement.

The Internet pharmacy module 204 comprises a web server 215 and a web application 213. The web server 216 serves up web pages from the web application 213 to the web browser 211 of the patient module 202. The web server 215 and the web application 213 execute on a server platform, for example, but other platforms are possible. The Internet pharmacy module 204 has the http association 228 with the patient module 202 and a TCP association 232 with the prescription authority module 206.

The prescription authority module 206 comprises a web application 217 and a prescription repository in the form of a database 221. The web application 217 and prescription repository database 221 execute and reside on a sever platform, but other platforms are possible. The prescription authority module 206 has the transmission control protocol (TCP) association 232 with the Internet pharmacy module 204. The web application 217 of the prescription authority module 206 sends and receives TCP messages with the web application 213 of the Internet pharmacy module 204 and communicates with the prescription repository database 221.

The registration and filling of an electronic prescription is now discussed. To create an electronic prescription, the application 201 of the doctor module 200 provides an electronic form on a display (not shown) in which the doctor enters the prescription information, e.g. the prescription information described above in previous embodiments. Once all the prescription information has been provided the doctor submits the form for processing by the application 201.

Referring to FIGS. 6 & 8a-d, the application 201 encapsulates the prescription information into a prescription file 208 that is digitally signed by the doctor. To digitally sign the file 208, the prescription file 208 is first crunched-down by the application 201 by a hashing process 212 into a message digest 214. The message digest 214 is then encrypted 216 by a private key 210 into a digital signature 218. The private key 210 is part of a public key infrastructure which has a corresponding public key. A modified prescription file 220 is created by deleting 219 a confidential item of patient information from the prescription file 208. The confidential item of patient information can be, for example without limitation, the patient's name, a password, a social security number or a health insurance number of the patient. The confidential item of patient information is not included in the digitally signed prescription file 222 so that the patient can provide that information when filling the electronic prescription. If the password is used, it is added by the application 201. The digital signature 218 is then appended 223 to the modified prescription file 220 and the resulting file is a digitally signed prescription file indicated generally by reference numeral 222. Note that in all embodiments of the present invention the electronic prescription is represented in different forms, e.g. the prescription file 208 and the digitally signed prescription file 222.

Referring again to FIGS. 6 & 8, once the digitally signed prescription file 222 is generated the application 201 communicates the file 222 to the SMTP client 203, and then the SMTP client 203 emails it to the patient via email message 226. The electronic prescription is now registered. The doctor by using the application 201 can print off a paper copy of all data items in the prescription file 208 organized into a conventional, paper prescription format that includes the password so that the patient can later refer to it when filling the prescription at an Internet pharmacy. It is generally preferable that the patient receive a paper copy of all the data items in the prescription file 208.

The SMTP client 209 of the patient module 202 receives the email message 226. The digitally signed prescription file 222 is not complete without the confidential item of patient information and therefore interception of the email is not likely to result in prescription fraud.

The patient uses the web browser 211 of the patient module 202 to surf to an Internet pharmacy website that is provided by the web application 213 of the Internet pharmacy module 204. Many of the messages between the web browser 211 of the patient module 202 and the Internet pharmacy module 204 are not shown in FIG. 7 for simplicity.

There are many possible use cases depending on whether this is the first visit of the patient to the Internet pharmacy website or a return visit. The use case of the first visit is now discussed, and there would be similar messages in other use cases.

The patient surfs to a web page listing a product (medicine or drug) they want to purchase within an HTML form. This may be performed in a variety of ways, for example selecting a medicine in a drop down box or by searching for the medicine. The patient sends a select product message 234 by selecting the product and posting the HTML form to the web application 213 so that the web application knows that the patient wants to purchase the product. The web application 213 returns another HTML form to the web server 211 requesting the patient's personal information, for example, the patient's name and mailing address. The HTML form also requests the confidential item of patient information removed from the prescription file 208 in the digitally signed prescription file 222 as discussed above. The patient sends an upload personal information message 236 by entering the required information and posting the HTML form to the web application 213. In a similar fashion, another form is returned to the web browser 211 requesting payment information for the product selected, for example, credit card number, expire date, name on card and shipping address. The patient sends an upload payment information message 238 by entering the required information and posting the form.

The web application 213 now returns a web page comprising an HTML form for filling the electronic prescription. That HTML form comprises a file upload input element that the patient uses to upload the digitally signed prescription file 222 to the web application 213. It is understood that the patient must first save the digitally signed prescription file 222 from the email message 226 to a file system accessible by the file upload input element of the HTML form. The patient selects the file upload input element to browse for and select the digitally signed prescription file 222 on the file system. The patient then sends an upload prescription message 240 by posting 240 this HTML form to the web application 213.

The web application 213 now has all the information required from the patient in order to authenticate the electronic prescription. The web application 213 further requires the public key corresponding to the private key 210 to authenticate the electronic prescription. In the present example the web application 213 already has the public key, which was obtained from the prescription authority module 206 previously when validating a previous electronic prescription from the same doctor. The prescription authority module 206 provided a digital certificate corresponding to the doctor which contained the public key corresponding to the private key 210.

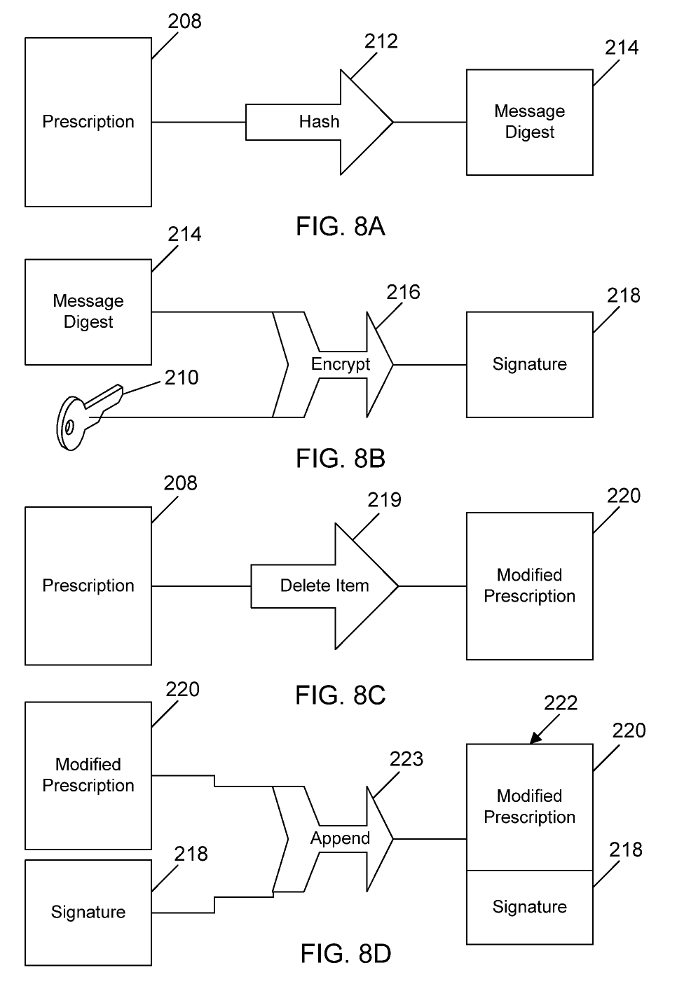

In order to authenticate, the web application 213 adds the confidential item of patient information to the modified prescription file 220 contained in the digitally signed prescription file 222 (see FIG. 8D) to recreate the prescription file 208. The web application 213 then hashes the recreated prescription file 208 into a second message digest, and using the public key the web application 213 decrypts the signature 218 in the file 222 back into a third message digest. If the second message digest is equivalent to the third message digest then the web application 213 knows that the electronic prescription came from the doctor and has not been changed.

In other embodiments, the doctor may use a symmetrical encryption procedure having a single private key instead of an asymmetric public key infrastructure. In this situation either the Internet pharmacy module 204 or the prescription authority module 206 would perform the authentication and would therefore also know the private key. When using a symmetrical encryption methodology it is preferable that the prescription authority module 206 is the only entity other than the doctor that knows the private key of the doctor.

If the electronic prescription did not pass the authentication test then a web page is returned to the web browser 211 indicating the failure, and possibly requesting the patient to try again. If the electronic prescription did pass the validation then the Internet pharmacy module 204 next attempts to fill the electronic prescription.

The Internet pharmacy module 204 sends a fill message 242 to the prescription authority module 206 that comprises at least the digitally signed prescription file 222 and the confidential item of patient information. The Internet pharmacy module 204 needs to send enough information to uniquely identify the electronic prescription. Therefore it is not a requirement that the digitally signed prescription file 222 be sent, but only enough information to uniquely identify the electronic prescription.

The prescription authority module 206 receives the fill message 242 and authenticates the electronic prescription again in this example. The web application 217 authenticates the electronic prescription using the same procedure described above for the Internet pharmacy module 204.

Assuming that the electronic prescription is authentic, the web application 217 then attempts to insert a record into the prescription repository database 221 representative of the electronic prescription, i.e. data items of the record correspond to data items in the electronic prescription. In this example, each record in the database is uniquely identified by the patient's name, the doctor's name, the date of the prescription and the medicine, i.e. these data items form a primary key for each record. In other examples other primary keys are possible. As is understood by those in the art, the alphanumeric primary key described above is less efficient then using a numerical index as the primary key. Therefore in other embodiments, the prescription file 208 can also include a numerical index that is used as the primary key. Each doctor prescribing electronic prescriptions would be given a range of numerical indices that they can issue.

If the insertion of the record into the database 221 succeeds then the record with that primary key was not inserted before and therefore has not been filled before. After insertion the prescription is then filled, but possibly has refills associated with it.

If the insertion of the record into the database 221 fails then the record with that primary is already in the database. In this situation the electronic prescription has been filled before. The web application 217 then reads (selects) a refill data item from the record in the database to determine if the electronic prescription has available refills. If there are available refills then the web application 217 updates the refill data item by decrementing its value by one. If there are not any available refills then the electronic prescription has been previously filled and has no refills.

The web application returns the result of the above procedure to the web application 213 of the Internet pharmacy module 204 in a fill response message 244. If the electronic prescription was successfully filled then the web application 213 returns a web page containing a purchase response message 246 to the web browser 211 of the patient module 202. If the electronic prescription could not be filled then the purchase response message 246 would indicate the reason why, i.e. it was previously filled and has no refills.

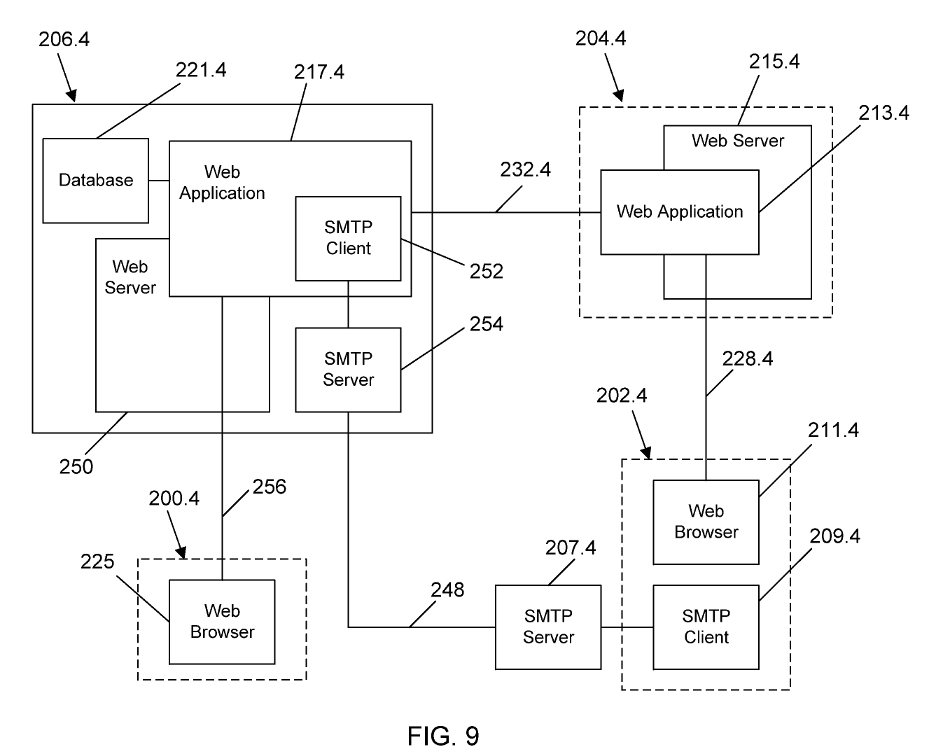

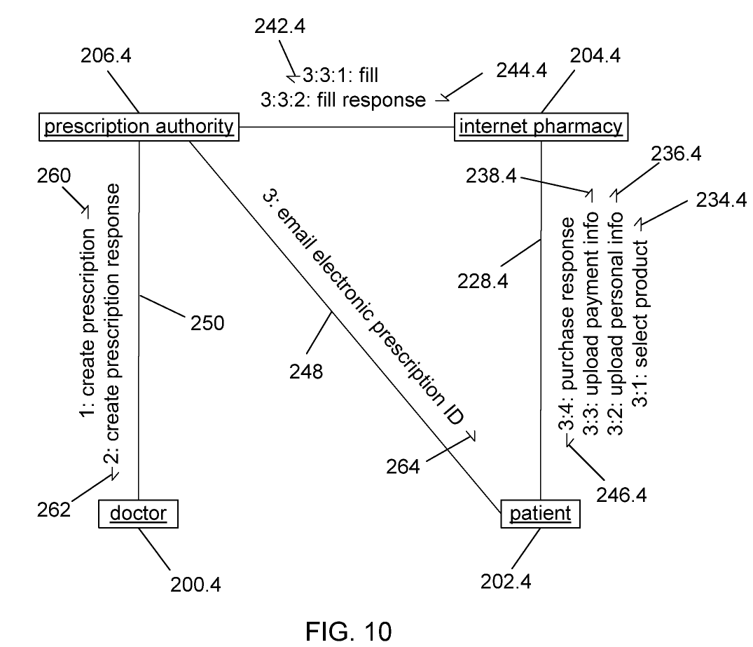

Referring now to FIGS. 9 & 10, a fourth embodiment of the system and method of the present invention is shown, wherein like parts have like reference numerals with an additional suffix “.4”. The present embodiment is exemplified by a software architecture shown in FIG. 9 and a collaboration diagram shown in FIG. 10 illustrating the message flow between elements in the software architecture. The elements in the software architecture and the collaboration diagram comprise the doctor module 200.4, the patient module 202.4, the Internet pharmacy module 204.4 and the prescription authority module 206.4. This embodiment is similar to the previous third embodiment and only the differences are discussed.

This embodiment has a network architecture similar to the previous embodiments and as illustrated in FIGS. 1 & 4. For example, the doctor module 200.4 can execute on personal computer 20, the patient module 202.4 can execute on personal computer 28, the Internet pharmacy module 204.4 can execute on server 32 and the prescription authority module 206.4 can execute on server 24. and messages in FIG. 10 go over network 18.

The doctor module 200.4 comprises a web browser 225. The web browser 225 preferably is a conventional web browser, e.g. Internet Explorer, which executes on a personal computer running a conventional operating system. The doctor module 200.4 enables a doctor to enter the prescription information described above in previous embodiments for a patient.

The patient module 202.4 is substantially similar to the previous third embodiment and comprises an email SMTP client 209.4 and a web browser 211.4, and is associated with the Internet pharmacy module 204.4 by an http association 228.4 and preferably with the prescription authority module 206.4 by email association 248.

The Internet pharmacy module 204 is similar to the previous third embodiment and comprises a web server 215.4 and a web application 213.4 that serves up web pages to the web browser 211.4 of the patient module 202.4 and that communicates using a TCP association 232.4 with the prescription authority module 206.4.

The prescription authority module 206.4 comprises a web server 250, a web application 217.4, an SMTP email client 252, and SMTP email server 254 and a prescription repository in the form of a database 221.4. The web server 250 serves up web pages from the web application 217.4 to the web browser 225 of the doctor module 200.4 over an http association 256. The web application 217.4 further communicates with the Internet pharmacy module 204.4 over the TCP association 232.4 and with the patient module 202.4 over the email association 248.

The registration and filling of an electronic prescription is now discussed. To create an electronic prescription, a doctor uses the web browser 225 to surf to a prescription authority website provided by the prescription authority module 206.4. The web application 217.4 provides a web page comprising an HTML form that the doctor uses to enter the prescription information. The doctor sends a create prescription message 260 by posting the form to the web application 217.4 for processing. It is preferable that the http association 256 be a secure connection, for example, using a public key infrastructure where the doctor has a private and public key. In most situations, the prescription authority module 206.4 would also be a certificate authority for the public key infrastructure, although this is not a requirement.

Upon receiving the create prescription message 260, the web application 217.4 verifies the data contents of the message and then inserts a record into the database that comprises the prescription information submitted by the doctor. The record has an index number associated with it that can be used to identify the record for later retrieval, i.e. a primary key of the record. The index number is referred to as the prescription identification number, i.e. the prescription ID.

The web application 217.4 returns a web page to the web browser 225 that includes a create prescription response message 262. The create prescription response message 262 is an HTML form that displays the prescription information submitted by the doctor and also the index number that identifies the database record, arranged in a format that can be printed. There can also be a password that is included in the create prescription response message 262, that is also in the record inserted into the database 221.4, and is used for enhanced security when filling prescriptions. The doctor can print this web page and hand a copy to the patient for their reference. The web application 217.4 also sends an email message 264 comprising the prescription information but excluding the prescription ID and the password to the patient. It is not a requirement to exclude the prescription ID and the password but is preferable for enhanced security.

The patient uses the web browser 211.4 of the patient module 200.4 to surf to an Internet pharmacy website that is provided by the web application 213.4 of the Internet pharmacy module 204.4. The message flow between the web browser 211.4 and the web application 213.4 is similar to the previous third embodiment. However, in the present embodiment the patient does not need to upload a digitally signed prescription file. Instead, when the patient enters their personal information they also enter the password and the prescription ID.

Upon receiving the personal information of the client, the prescription ID, the password and the payment info the Internet pharmacy module 204.4 sends a fill message 242.4 to the prescription authority module 206.4. The fill message 242.4 comprises sufficient information for the web application 217.4 of the prescription authority module 206.4 to identify the record of the electronic prescription in the database 221.4. Minimally this requires the primary key which is the prescription ID. However, for enhanced security further information can be required such as the password, the patient's name and mailing address. The web application 217.4 can conveniently select the record using the primary key and can then further verify data items in the record against the extra information provided by the patient through the web browser 211.4.

If the web application 217.4 can not select a record based on the primary key or can not successfully cross-reference the extra information then it returns a failed response in the fill response message 244.4. The web application 213.4 of the Internet pharmacy module 204.4 then returns a purchase response message 246.4 to the web browser 211.4 indicating that the prescription fill attempt failed, and possibly requesting the patient to try again.

If the web application 217.4 can successfully select a record and cross-reference the extra information provided by the patient with the data items in the record then it is understood that the patient is the true recipient of the electronic prescription. The web application then determines whether the prescription can be filled. When the record representing the electronic prescription was first inserted into the database 221.4 it included a data item that indicated the number of times the prescription can be filled. Each time the prescription is filled that data item is decremented. Therefore the web application 217.4 checks this data item each time it is attempting to fill the prescription to verify that it is greater than or equal to 1. If that data item is greater than or equal to one the web application 217.4 decrements it by one, and updates the record in the database to reflect this, and returns a success response in the fill response message 244.4. If it is not greater than or equal to one the web application 217.4 returns a failed response in the fill message 244.4. The Internet pharmacy module 204.4 serves a web page to the web browser 211.4 indicating the success or failure of the electronic prescription fill attempt.

It is understood that the Internet pharmacy module 204 and 204.4 and the prescription authority module 206 and 206.4 can be co-located at the same premise and therefore communicate over a local area network instead of over the Internet, or by RPCs. It is also possible that the Internet pharmacy module 204 and 204.4 and the prescription authority module 206 and 206.4 are components of a single software application executing on the same platform and therefore communicate using method calls.

The previous embodiments are some examples of protocols between the doctor module 200, the patient module 202, the Internet pharmacy module 204 and the prescription repository software 206, however, there can be other examples of the protocols having different message sequences.

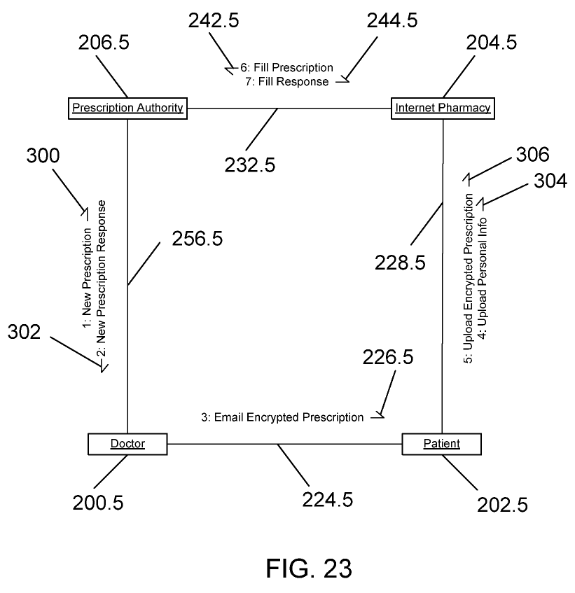

Referring now to FIG. 23, a collaboration diagram of another embodiment of the present invention is shown wherein like parts have like reference numerals with an additional suffix “.5”. The present embodiment can have a similar software architecture to that shown in FIGS. 6 and 9. The elements in the collaboration diagram of FIG. 23 comprise a doctor module 200.5, a patient module 202.5, an Internet pharmacy module 204.5 and a prescription authority module 206.5. The collaboration diagram illustrates the messages that are exchanged between the software modules 200.5, 202.5, 204.5 and 206.5.

In this example the present embodiment has a network architecture similar to the previous embodiments and as illustrated in FIGS. 1 & 4. For example, the doctor module 200.5 can execute on the personal computer 20 (see FIG. 1), the patient module 202.5 can execute on the personal computer 28, the Internet pharmacy module 204.5 can execute on the server 32 and the prescription authority module 206.5 can execute on the server 24 and messages in FIG. 23 go over the network 18.

A doctor interacts with the doctor module 200.5 to create an electronic prescription in the form of a digital file by entering prescription information and patient personal information. The doctor module 200.5 then performs the digital signing procedure described previously and illustrated in FIGS. 8A & 8B, however, in this example the digital signature for the electronic prescription is not appended to the electronic prescription file. It is understood that the doctor has a public-private key pair for asymmetrical encryption/decryption in a public key infrastructure.

The doctor module 200.5 sends a new prescription message 300 over connection 256.5 to the prescription authority module 206.5. The new prescription message 300 comprises the digital signature (without the electronic prescription file) and some of the patient personal information. The connection 256.5 is a secure socket layer (SSL) connection in this example. The prescription authority module 206.5 enters a new prescription record in a prescription repository database. The new prescription record comprises a prescription identification number (ID), the digital signature and the patient personal information. The prescription record also comprises other database fields, for example, the number of times the prescription has been filled.

The prescription authority module 206.5 then sends a new prescription response message 302 to the doctor module 200.5. The new prescription response message 302 comprises the prescription ID.

Next, the doctor module 200.5 uses the patient personal information to create a symmetrical key for encryption and decryption. The patient personal information used to create the symmetrical key can be chosen from the group of first name, last name, date of birth, zip code, gender, place of birth and mother's maiden name, for example, but other personal confidential information can also be used. It is preferred that at least one piece of patient personal information be chosen that only the patient would know. The symmetrical key is preferably at least 16 characters long and comprises alphanumeric characters chosen from the group of patient information selected, and preferably the characters are chosen in an alternating fashion, i.e. successive characters are selected from different items of personal information. In other embodiments the symmetrical key does not need to be selected from the patient personal information, but instead can be chosen randomly. The doctor module 200.5 uses the symmetrical key to encrypt the electronic prescription file forming an encrypted prescription file.

The doctor module 200.5 then sends an email message 226.5 to the patient module 202.5 over the email association 224.5. The email message 226.5 comprises the encrypted prescription file and the prescription ID. The doctor module 200.5 can also print a paper copy of the prescription comprising the prescription information and the patient personal information.

The patient selects an Internet Pharmacy in which to fill the prescription. The patient interacts with the patient module 202.5 to fill the prescription. The patient module 202.5 sends a personal information message 304 to the Internet pharmacy module 204.5 over the connection 228.5. The connection 228.5 is a secure socket layer connection in this example. The personal information message 304 comprises at least the patient personal information that was used to create the symmetrical encryption key and the personal information that was uploaded to the prescription authority in the new prescription message 300. The patient module 202.5 also sends an encrypted prescription message 306 to the Internet pharmacy module 204.5. The encrypted prescription message 306 comprises the encrypted prescription and preferably the prescription ID. The encrypted prescription message 306 can be an email or can be a file upload. The encrypted prescription message 306 does not need to be over a secure socket layer connection, and typically is not if the message 306 is an email. In other embodiments that use the randomly selected symmetrical key, the patient module 202.5 can also send this key to the Internet pharmacy module 204.5 as part of the personal information message 304 or in another message.

The Internet pharmacy module 204.5 uses the patient personal information to recreate the symmetrical key, and then uses the key to decrypt the encrypted prescription file. In other embodiments that use the randomly selected symmetrical encryption key, the Internet pharmacy decrypts the encrypted prescription file and then cross references the patient personal information received from the patient module 202.5 with that in the prescription file. The Internet pharmacy module 204.5 can then present the patient with possible product selections that the patient can purchase in order to fill the prescription. The messaging is not shown for the product selection for simplicity.

After the patient selects a product, the Internet pharmacy module 204.5 sends a fill prescription message 242.5 to the prescription authority module 206.5 over the secure socket layer connection 232.5. The fill prescription message 242.5 comprises the prescription ID, the patient personal information and the number of refills the prescription is allowed. The number of refills is contained within the decrypted electronic prescription file.

The prescription authority module 206.5 uses the prescription ID to retrieve the corresponding prescription record from the prescription repository database. The prescription authority module 206.5 then cross-references the patient personal information in the prescription record with the patient personal information in the fill prescription message 242.5 to further validate the fill prescription request. If the patient information is not the same then the prescription authority aborts the fill prescription request and reports the reason why to the Internet pharmacy module 204.5.

If the patient personal information was successfully cross-referenced, the prescription authority module 206.5 then cross references the entry in the number of times filled column in the prescription record with the number of refills allowed number within the fill prescription message 242.5. If the prescription has not yet been filled or still has refills, then the prescription authority modules updates the prescription record by incrementing the number of times filled column and returns the digital signature of the electronic prescription in a fill response message 244.5 to the Internet pharmacy module 204.5. The digital signature is used by the Internet pharmacy module 204.5 as confirmation that the electronic prescription came from an authorized doctor. The Internet pharmacy module 204.5 can validate the electronic prescription file against the digital signature by the process described above in previous embodiments.

It is understood that in other embodiments the Internet pharmacy module 204.5 can validate the electronic prescription with the prescription authority module 206.5, i.e. if the electronic prescription has not yet been filled or has refills yet to be filled, before presenting product selections to the patient.

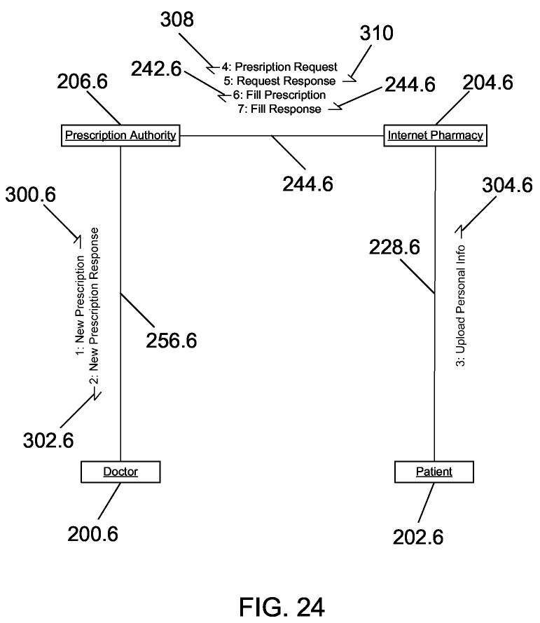

Referring now to FIG. 24, a collaboration diagram of another embodiment of the present invention is shown wherein like parts have like reference numerals with an additional suffix “.6”. The present embodiment can have a similar software architecture to that shown in FIGS. 6 and 9. The elements in the collaboration diagram of FIG. 24 comprise a doctor module 200.6, a patient module 202.6, an Internet pharmacy module 204.6 and a prescription authority module 206.6. The collaboration diagram illustrates the messages that are exchanged between the software modules 200.6, 202.6, 204.6 and 206.6.

In this example the present embodiment has a network architecture similar to the previous embodiments and as illustrated in FIGS. 1 & 4. For example, the doctor module 200.6 can execute on the personal computer 20, the patient module 202.6 can execute on the personal computer 28, the Internet pharmacy module 204.6 can execute on the server 32 and the prescription authority module 206.6 can execute on the server 24 and messages in FIG. 24 go over the network 18.

This example is similar to the previous example of FIG. 23, however, for each new electronic prescription a new prescription message 300.6 now comprises a digital signature of the doctor for the electronic prescription, personal information of the patient and an encrypted prescription. The digital signature is created in a manner similar to that described in previous embodiments and illustrated in FIGS. 8A & 8B. The encrypted prescription is encrypted using a symmetrical key derived from the patient information, as described in the previous embodiment. In other examples the symmetrical key can be randomly chosen. The encrypted prescription is not emailed to the patient's inbox. When the patient personal information is used to create the symmetrical key, not all the patient personal information used to create the symmetrical key is included in the new prescription message 300.6 so that the prescription authority module 206.6 can not recreate the symmetrical key. Enough of the patient personal information is included in the message 300.6 to uniquely identify a group of prescriptions belonging to the patient.

A new prescription record is created in a prescription repository database in the prescription authority module 206.6 for reach new prescription message 300.6, and comprises a prescription identification number (ID), the digital signature of the electronic prescription, the encrypted prescription and the patient personal information. The prescription authority module 206.6 returns a new prescription response message 302.6 to the doctor module 200.6 indicating the success of the new prescription message 300.6. In some embodiments the new prescription response message 302.6 can comprise the prescription ID that can be used to identify the electronic prescription when the patient fills the electronic prescription at an Internet pharmacy. The doctor module may print a page of paper comprising the prescription information, including the prescription ID, for the patients convenience.

As in the previous example, the patient interacts with the patient module 202.6 to fill the prescription. The patient module 202.6 uploads the patient personal information to the Internet pharmacy module 204.6. The patient personal information uploaded comprises all the information necessary to recreate the symmetrical key and to identify the group of prescriptions that belong to the patient in the prescription repository database in the prescription authority module 206.6.

The Internet pharmacy module 204.6 then sends a prescription request message 308 to the prescription authority module 206.6 comprising the personal information of the patient required to identify the group of prescriptions belonging to the patient. The prescription authority module 206.6 selects all the encrypted prescriptions in the database that match the patient personal information and returns a request response message 310 to the Internet pharmacy module comprising the encrypted prescriptions. The request response message 310 can also include the prescription ID for those embodiments that require further security.

The Internet pharmacy module 204.6 uses the symmetrical key recreated from the patient personal information to decrypt each of the encrypted prescriptions returned in the message 310. In those embodiments that require further security, the Internet pharmacy module 204.6 can request the prescription IDs for each of the encrypted prescriptions from the patient module 202.6 before decryption. There is next a series of messages between the Internet pharmacy module 204.6 and the patient module 202.6 wherein products are presented to the patient and the patient then selects those products and prescriptions they wish to purchase and fill respectively.

The remainder of the operation is similar to the previous embodiment wherein the Internet pharmacy module submits a fill prescription message 242.6 to the prescription authority module 206.6 and receives a fill response message 244.6 from the prescription authority module 206.6 comprising the digital signature of the doctor for each of the successfully filled electronic prescriptions.

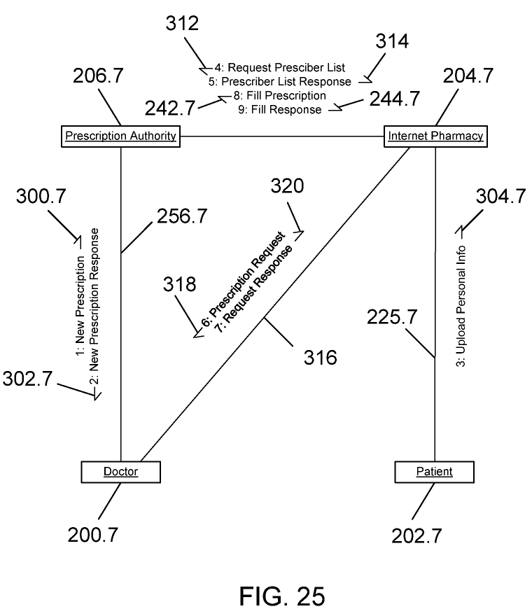

Referring now to FIG. 25, a collaboration diagram of another embodiment of the present invention is shown wherein like parts have like reference numerals with an additional suffix “.7”. The present embodiment can have a similar software architecture to that shown in FIGS. 6 and 9. The elements in the collaboration diagram of FIG. 25 comprise a doctor module 200.7, a patient module 202.7, an Internet pharmacy module 204.7 and a prescription authority module 206.7. The collaboration diagram illustrates the messages that are exchanged between the software modules 200.7, 202.7, 204.7 and 206.7.

In this example the present embodiment has a network architecture similar to the previous embodiments and as illustrated in FIGS. 1 & 4. For example, the doctor module 200.7 can execute on the personal computer 20, the patient module 202.7 can execute on the personal computer 28, the Internet pharmacy module 204.7 can execute on the server 32 and the prescription authority module 206.7 can execute on the server 24 and messages in FIG. 25 go over the network 18.

In this embodiment electronic prescriptions are created by the doctor module 200.7 and are stored in a prescription repository database in the doctor module 200.7, which is described in more detail below. This embodiment therefore has a distributed prescription repository architecture, since there may be more than one doctor module 200.7.

For each new electronic prescription, the doctor module 200.7 sends a new prescription message 300.7 comprising patient personal information and a digital signature for the electronic prescription over the secure socket layer connection 256.5. The digital signature is created in a manner similar to that illustrated in FIGS. 8A & 8B. Note that the electronic prescription is not sent to the prescription authority and the prescription authority has no information about the medication (type, dose, quantity).

The prescription authority module 206.7 creates a new prescription record in a prescription repository database in the module 206.7. The prescription record comprises a prescription identification number (ID), the digital signature of the prescription, a doctor identifier and a network address of the doctor module 200.7. The network address can be the Internet Protocol (IP) address of the doctor module 200.7, which is preferably a static IP address.

The prescription authority 206.7 returns a new prescription response message 302.7 to the doctor module 200.7 comprising the prescription ID. The doctor module 200.7 then creates a new prescription record in the local prescription repository database that comprises the prescription ID and the electronic prescription. Note that the digital signature of the doctor for the electronic prescription is not stored locally in this example, although it can be in other examples.

As in the embodiments of FIGS. 23 and 24, the patient interacts with the patient module 202.7 to fill the electronic prescription and the patient module 202.7 sends the patient personal information to the Internet pharmacy module 204.7 in a similar manner.

When the Internet pharmacy module 204.7 receives the patient personal information from the patient module 202.7, it sends a request prescriber list message 312 to the prescription authority module 206.7. The request prescriber list message 312 comprises enough of the patient personal information so that the prescription authority module 206.7 can select all the prescription records in the prescription repository database in the prescription authority module 206.7 that belong to that patient. After the prescription authority module 206.7 has selected all the corresponding prescription records, it then comprises a prescription list of prescription IDs and the respective network addresses of the doctor modules 200.7 for each of those prescription IDs. The prescription authority module 206.7 then sends a prescriber list response message 314 comprising the prescription list to the Internet pharmacy module 204.7.

The Internet pharmacy module 204.7 then parses the prescription list to determine how many doctor modules 200.7 currently have electronic prescriptions for the patient, as represented by the number of unique network addresses there are in the prescription list. The Internet pharmacy module 204.7 then sends a prescription request message 318 to each of the doctor modules 200.7 over connection 316, which is a secure socket layer connection in this example. Each of the prescription request messages 318 comprises the prescription IDs of the electronic prescriptions for the patient that are stored in the prescription repository database in respective ones of the doctor module 200.7.

After receiving the prescription request message 318, the doctor module 200.7 selects the electronic prescriptions identified by the respective prescription IDs in the prescription request message 318 and returns those electronic prescriptions in a request response message 320 to the Internet pharmacy module 204.7.

The remaining operation is similar to that described previously in relation to FIGS. 23 and 24. The Internet pharmacy module 204.7 exchanges a series of messages with the patient module 202.7 to select one or more products to purchase in order to fill the one or more of the electronic prescriptions respectively. The Internet pharmacy module 204.7 further exchanges messages with the prescription authority module 206.7 to fill the one or more electronic prescriptions and to receive the respective digital signature for each of the filled electronic prescriptions.

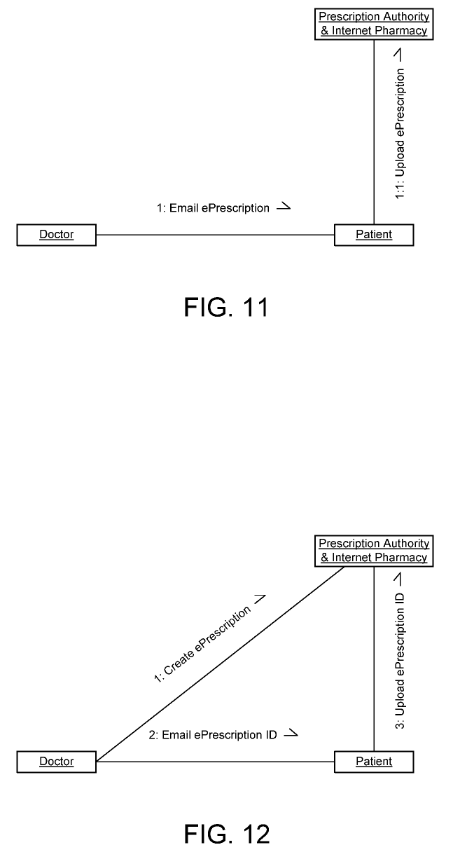

Referring to FIGS. 11 through 21, several alternative embodiments are shown and the differences between them are briefly discussed. FIG. 11 shows an embodiment where an Internet pharmacy is also a prescription authority, and where a doctor module emails an electronic prescription to a patient's inbox, which the patient then uploads to Internet pharmacy and prescription authority module in order to fill the prescription. FIG. 2 shows a similar embodiment to FIG. 1 except that a doctor module creates an electronic prescription directly with a prescription authority which is also an Internet pharmacy. In this situation the patient uploads a prescription ID to Internet pharmacy and prescription authority module.

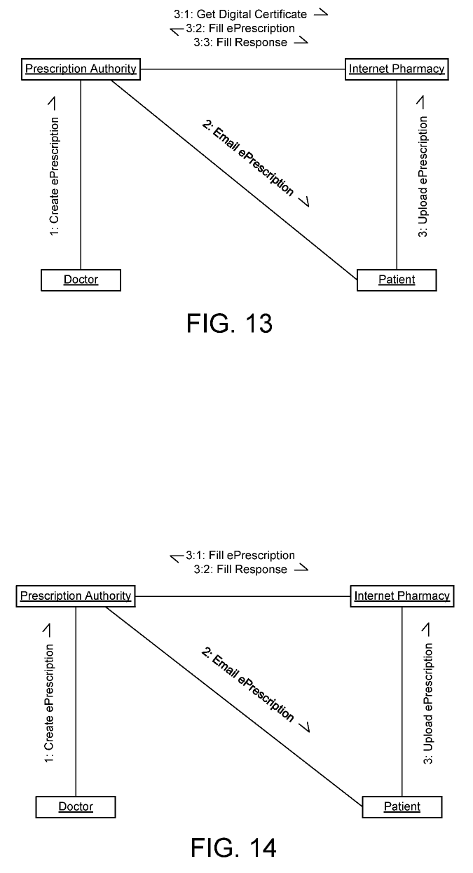

Referring to FIGS. 13 and 14, these show a doctor module creating an electronic prescription directly with prescription authority module and the prescription authority module then emails the electronic prescription to a patient's inbox. The patient uploads the electronic prescription to an Internet pharmacy module. FIG. 13 shows the situation where an asymmetric key cryptology scheme is used and the Internet pharmacy can authenticate the electronic prescription. FIG. 14 shows a situation where a symmetric key cryptology scheme is used and only the prescription authority module can authenticate the electronic prescription. In both FIGS. 13 and 14 the prescription authority module maintains an electronic prescription repository and manages the filling of prescriptions.

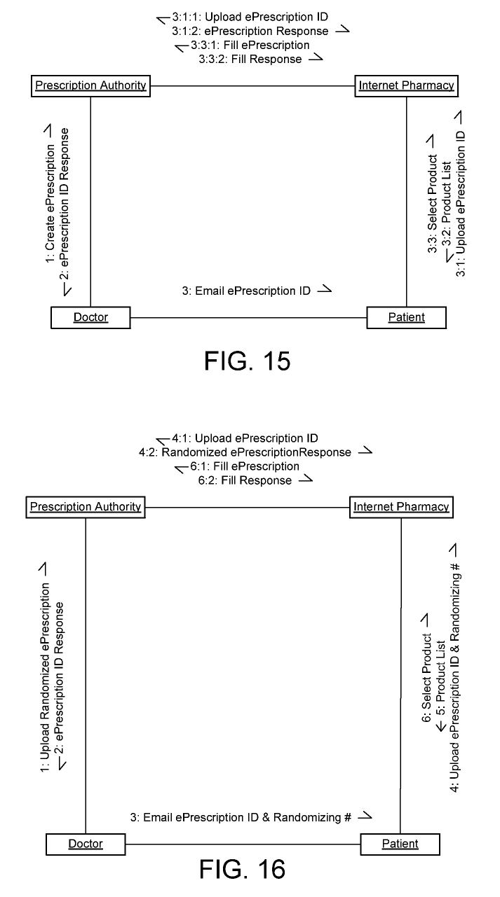

Referring now to FIG. 15, this shows a situation where the patient receives and then uploads an electronic prescription ID, and preferably additional security information, to an Internet pharmacy module. The Internet pharmacy module then retrieves the electronic prescription from prescription authority module and returns a product list to patient module. The patient then selects a product to purchase and submits this to the Internet pharmacy module which then fills the prescription with the prescription authority module.

Referring now to FIG. 16, this shows a situation where a doctor module uploads a randomized (scrambled) electronic prescription to prescription authority module to be stored in an electronic prescription repository. The randomized electronic prescription is similar to a randomized message that is to be signed by a third party during a blind signature scheme. The randomized electronic prescription contains no useful information that the prescription authority can use. A prescription ID and randomizing number are then emailed to the patient. The patient uploads the prescription ID and randomizing number to an Internet pharmacy module that then retrieves the randomized prescription from the prescription authority module and de-randomizes the electronic prescription so that a product list can be returned to patient module. The remaining operation is similar to FIG. 15. It is noteworthy that the prescription authority is blinded to the electronic prescriptions it is authorizing. The Internet pharmacy module must provide enough information to the prescription authority module in order to uniquely, and preferably securely, identify the electronic prescription, e.g. an electronic prescription ID and password which is provided initially in the electronic prescription ID response message.

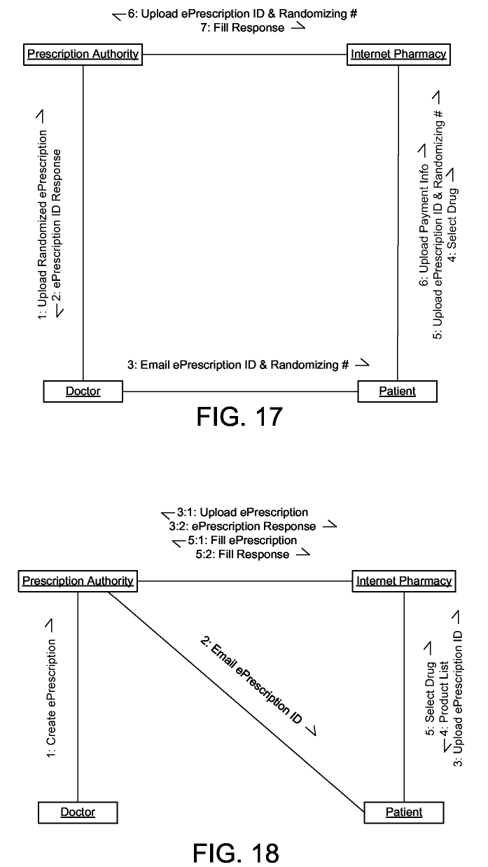

Referring now to FIG. 17, this shows a situation similar to FIG. 16, except that prescription authority module receives the randomizing number from an Internet pharmacy module and authenticates the electronic prescription and validates the fill request of the patient.

Referring now to FIG. 18, this shows a situation similar to FIG. 10 except that the patient does not initially select a product. Instead the patient first submits an electronic prescription ID to an Internet pharmacy module, which then retrieves the electronic prescription from prescription authority module and then returns a product list to patient module so that the patient can select a product.

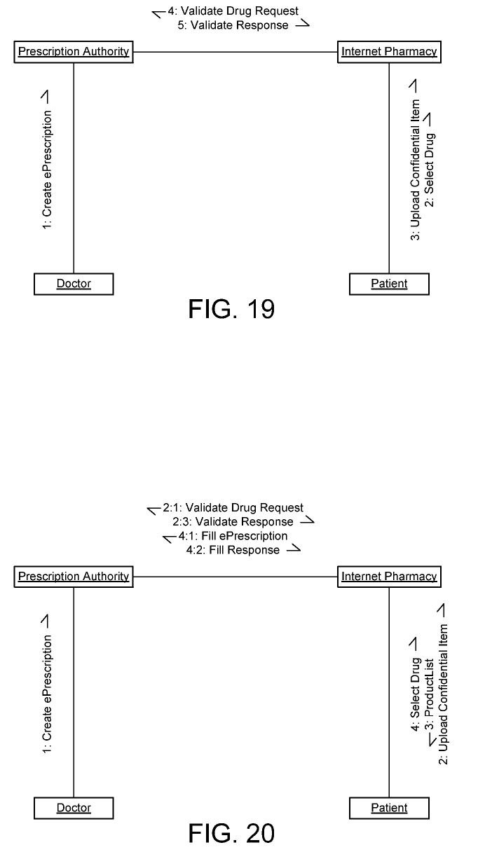

Referring now to FIG. 19, this shows a situation where the patient uploads a confidential item of personal information, and preferably two or more items, to uniquely identify them and a drug selection to an Internet pharmacy module. The Internet pharmacy module then passes on this request to prescription authority module which validates that this patient has a prescription for that particular drug. FIG. 20 is similar to FIG. 19 except the patient first uploads only the confidential items of patient information and if they do have an electronic prescription in the prescription authority they are given a product list they can select from.

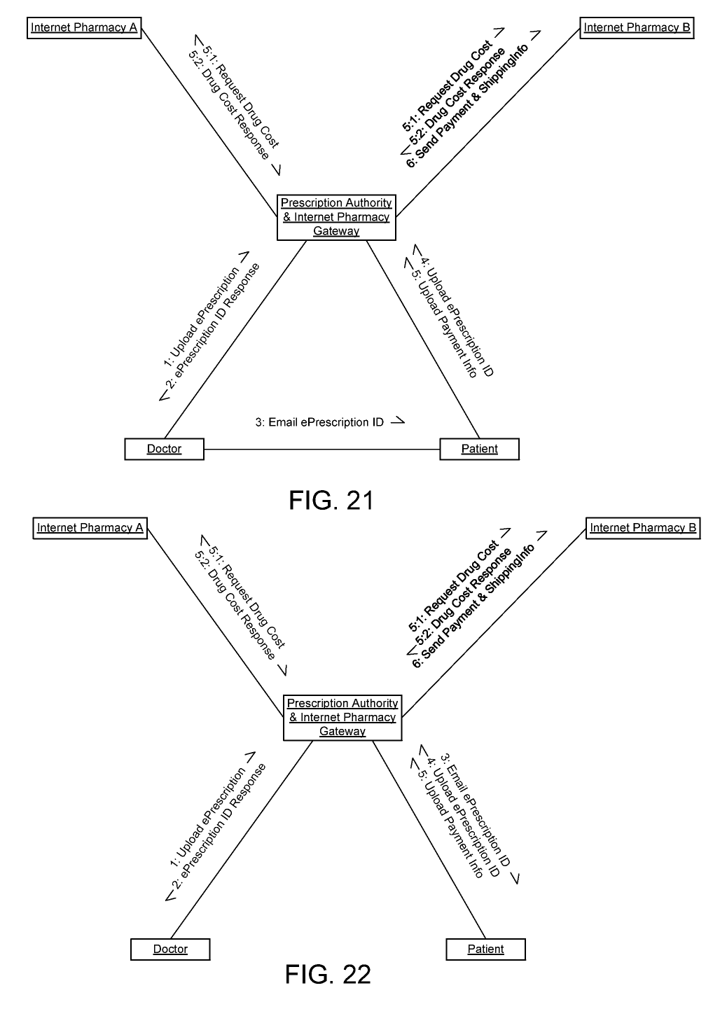

Referring now to FIGS. 21 and 22, these show a situation similar to FIG. 10 where a patient uploads an electronic prescription ID and payment info to prescription authority module which validates the electronic prescription and also acts as a gateway to one and preferably several Internet pharmacies. The prescription authority module can request cost information for a drug prescribed in the electronic prescription from the Internet pharmacies and then proceed to pass on the payment and shipping information to the Internet pharmacy with the lowest cost.

For all the previous embodiments, when the Internet pharmacy does not explicitly handle the electronic prescription, the prescription authority can provide a copy of the electronic prescription, digitally signed by the prescribing doctor or the prescription authority, to the Internet pharmacy for its own records. It is typically a requirement that a pharmacy that is dispensing prescription medication have a copy of the prescription.

It is a further requirement that the prescription copy mentioned above in the Internet pharmacy be signed by a physician authorized to practice medicine in the region of the Internet pharmacy. Therefore, in the situations where the prescribing doctor is not in the same region as the Internet pharmacy dispensing the medication prescribed in the electronic prescription, then the electronic prescription can be digitally signed by a physician authorized to practice medicine in the dispensing region, and this is referred to as the authorizing digital signature.

The authorizing digital signature can be added to the electronic prescription by the prescription authority, the Internet pharmacy or some other entity. In either situation, the electronic prescription is first reviewed for correctness by applying prescription rules to the electronic prescription. The prescription rules vary from region to region, but may include checks for maximum number of refills or maximum amount of drug prescribed. Once the electronic prescription is verified for correctness then it can be digitally signed by the authorizing physician in a similar manner described above in relation to FIGS. 8A-D. Of course, this process is completely carried out under software control provided by instructions in, for example, the prescription authority module or the Internet pharmacy module.

It is understood that in all embodiments of the present invention when a prescription ID is emailed to the patient's inbox, the email is for the convenience of the patient and is not a requirement. The paper copy printed by the doctor and given to the patient is also not a requirement. However, if the patient needs to enter a prescription ID or a password when filling their prescription at an Internet pharmacy website then the paper copy and email serve as aids to the patient.

It is understood by those skilled in the art that instead of using Java technologies, an equivalent or substantially similar software architecture can be obtained by using other software technologies, for example, without limitation, C, C++, Visual C#, Visual C++, Visual Basic and Microsoft NET technologies.

As will be apparent to those skilled in the art, other modifications may be made to the above described invention within the scope of the appended claims.

What is claimed is:

1. An electronic prescription system comprising:
a first prescription processor being configured to provide prescription information for creating an electronic prescription for a patient;
a second prescription processor being configured to provide an electronic prescription processing service; and
a third prescription processor being configured to accept a sequence of digits representative of the electronic prescription from the patient and to provide the second prescription processor with said sequence of digits.

2. The electronic prescription system of claim 1, wherein the second prescription processor comprises a database for storing and retrieving the electronic prescription.

3. The electronic prescription system of claim 1, wherein the first prescription processor comprises an email means for emailing the sequence of digits representative of the electronic prescription to the patient.

4. The electronic prescription system of claim 1, wherein the second prescription processor comprises an email means for emailing the sequence of digits representative of the electronic prescription to the patient.

5. The electronic prescription system of claim 1, wherein the first prescription processor comprises a first electronic prescription application running on a second service control point.

6. The electronic prescription system of claim 1, wherein the second prescription processor comprises a second electronic prescription application running on a second service control point.

7. The electronic prescription system of claim 1, wherein the third prescription processor comprises a third electronic prescription application running on a third service control point.

8. An electronic prescriptions method for providing an electronic prescription service to a patient, the method comprising the steps of:
providing the patient with a sequence of digits representative of the electronic prescription; and
the patient providing the sequence of digits representative of the electronic prescription over the Internet.

9. The electronic prescriptions method of claim 8, wherein the method further comprises the step of validating the electronic prescription represented by the sequence of digits.

10. The electronic prescriptions method of claim 9, wherein the method further comprises the step of filling the electronic prescription.

11. An electronic prescriptions apparatus for providing an electronic prescription service to a patient, the apparatus comprising:
means for providing the patient with a sequence of digits representative of the electronic prescription; and
means for the patient providing the sequence of digits representative of the electronic prescription over the Internet.

12. The electronic prescriptions method of claim 12, wherein the apparatus further comprises means for validating the electronic prescription represented by the sequence of digits.

13. The electronic prescriptions method of claim 13, wherein the apparatus further comprises means for filling the electronic prescription.
